(19) United States
(12) Patent Application Publication
(10) Pub. No.: US 2016/0225008 A1
(43) Pub. Date: Aug. 4, 2016

(54) SYSTEM AND METHOD FOR PROVIDING PERSONALIZED COUPON, AND POINT SERVICE SERVER

(71) Applicant: SK PLANET CO., LTD., Seongnam-si (KR)

(72) Inventors: Je Hoon SONG, Seoul (KR); In Seok CHOI, Seoul (KR)

(21) Appl. No.: 14/957,144

(22) Filed: Dec. 2, 2015

(30) Foreign Application Priority Data
Feb. 3, 2015 (KR) 10-2015-0016768

(51) Int. Cl. G06Q 30/02

(52) U.S. Cl. CPC G06Q 30/0233

(57) ABSTRACT

A personalized coupon providing system, a point service server and a personalized coupon providing method. The point service server creates and transmits a personalized coupon to each of a plurality of customer terminals and, if the customer terminal receives personal purchase information corresponding to the personalized coupon and a store terminal receives in-store purchase card information, confirms the customer terminal, and applies a point accumulation rate or a price discount rate to a purchase product. A manufacturer terminal transmits product data. The customer terminal receives the personalized coupon and transmits the personal purchase information including information on a product to be purchased to the point service server. The store terminal transmits, if information on a point card is input, the in-store purchase card information to the point service server, receives information on a receipt to which the accumulation rate or the discount rate is applied, and outputs the receipt.

### BACKGROUND OF THE INVENTION

1. Field of the Invention

The present invention relates to a personalized coupon providing system, a point service server and a personalized coupon providing method, and more specifically, to a system and method for providing a personalized coupon, which creates and transmits a personalized coupon to each of a plurality of customer terminals and, if the customer terminal receives personal purchase information corresponding to the personalized coupon and a store terminal receives in-store purchase card information, confirms the customer terminal by matching the in-store purchase card information and the personal purchase information, and applies a point accumulation rate or a price discount rate to a purchase product according to the personal purchase information.

2. Background of the Related Art

In a market of modern society for providing customer services, various kinds of coupons are provided online for the purpose of advertising a product and encouraging purchase of the product owing to the advancement in information communication technologies. Particularly, mobile coupons spotlighted recently are advantageous in that it is possible to receive basic data needed from the aspect of Customer Relationship Management (CRM) and transfer three functions of discount, accumulation and advertisement to a user in one message.

Although it is general that such mobile coupons are issued only for personal members who wish to receive the coupons and encourage the members to purchase a product using the coupons to increase sales accordingly, since the target of the coupons is all personal members in an online space, the number of coupons leading to actual purchase is remarkably smaller than the number of issued coupons, and thus it is difficult to determine a commission for the coupon or an advertisement fee which should be collected by an advertisement agency or a coupon management agency from member stores.

Accordingly, although a conventional advertisement agency or coupon management agency uses a method of counting the number of coupons used when a personal member purchases a product and claiming a fee for issuing the coupon based on the number of coupons, since the member store cannot confirm a state of issuance of coupons to personal members in real-time at the moment of claiming the coupon issuance fee, it is difficult for the member store or a person who requests issuance of coupons to estimate an advertisement effect obtained by issuing the coupons.

In addition, since such coupons are provided for a limited time only by specifying a deadline or only a predetermined number of coupons are provided by limiting the number of downloaded coupons, the coupons are not issued to personal members who are sure to purchase a product by actually using the coupons, and thus customers move to other competing companies, and since the coupons can be easily downloaded online, the number of actually used coupons is extremely small compared with the number of downloaded coupons, and the advertisement effect obtained by issuing the coupons does not reach an expectation level desired by member stores in many cases.

Meanwhile, in the case of conventional mobile coupons, since coupons of similar contents are provided to many unspecified persons without grasping purchase states of consumers and product purchase patterns of target customers targeting personal members, the use rate of the coupons is lowered, and it makes a user troublesome since the user should present a coupon and a point card when the user accumulates points after purchase.

Although an apparatus and method for conducting custom-tailored target marketing by way of transmitting a discount coupon appropriate to a specific customer or informing performance of an event of a giveaway/drawing/anniversary or the like has been proposed in the prior patent document described below to overcome such problems, it is difficult to estimate an advertisement effect obtained by issuing the coupons, and a supporting tool such as a card, an application or the like which can facilitate discount of a price and accumulation of points when a user makes a purchase is not used.

### SUMMARY OF THE INVENTION

Therefore, the present invention has been made in view of the above problems, and it is an object of the present invention to provide a point system for transmitting a personalized coupon targeting a customer of high purchase involvement, performing a custom-tailored discount in an online or offline space if the customer reserves or directly purchases a product using the coupon, and providing a service such as confirmation of a coupon, accumulation of points, management of the points or the like through a point card.

Particularly, another object of the present invention is to provide a personalized coupon providing system for providing a custom-tailored coupon for each customer, which transmits a personalized coupon to a customer terminal if a manufacturer terminal requests to transmit a personal custom-tailored coupon targeting a specific customer, and applies a point accumulation rate or a discount rate for a corresponding customer by comparing the personal purchase information of the customer terminal and in-store purchase card information of a store terminal.

Technical problems to be achieved by the present invention are not limited to the technical problems mentioned above, and various technical problems can be included within the scope apparent to those skilled in the art from the following descriptions.

To accomplish the above objects, according to one aspect of the present invention, there is provided a personalized coupon providing system including a point service server for creating and transmitting a personalized coupon to each of a plurality of customer terminals and, if the customer terminal receives personal purchase information corresponding to the personalized coupon and a store terminal receives in-store purchase card information, confirming the customer terminal by matching the in-store purchase card information and the personal purchase information, and applying a point accumulation rate or a price discount rate to a purchase product according to the personal purchase information.

At this point, the personalized coupon providing system according to an embodiment of the present invention further includes a manufacturer terminal for transmitting a product data; the customer terminal for receiving the personalized coupon and transmitting the personal purchase information including information on a product to be purchased to the point service server; and the store terminal for transmitting, if information on a point card is input, the in-store purchase card information of the point card to the point service server, receiving information on a receipt to which the accumulation rate or the discount rate is applied, and outputting the receipt information.

Meanwhile, the point service server according to an embodiment of the present invention includes: an analysis unit for analyzing a product data transmitted from a manufacturer terminal and creating a personalized coupon for each of a plurality of customer terminals; a communication unit for transmitting and receiving data to and from any one of the manufacturer terminal, the customer terminal and a store terminal and transmitting the personalized coupon to the customer terminal; a control unit for confirming, if the customer terminal receives personal purchase information corresponding to the personalized coupon and the store terminal transmits in-store purchase card information, the customer terminal by matching the in-store purchase card information and the personal purchase information; a point management unit for applying a point accumulation rate or a price discount rate to a purchase product according to the personal purchase information of the customer terminal; and a storage unit for storing data including at least one or more of the personalized coupon, the product data, the personal purchase information and the in-store purchase card information.

At this point, in the point service server according to an embodiment of the present invention, the analysis unit analyzes the product data including at least one or more of a product quantity, a product name, a product data code, provided product points, a product manufacturer and an event period and creates personalized coupons of different discount rates or different accumulation rates for different customer terminals.

In addition, in the point service server according to an embodiment of the present invention, when a personalized coupon is created for each customer terminal, the analysis unit analyzes accumulated purchased products of the customer terminal and creates a personalized coupon of a discount rate or an accumulation rate increased as much as a predetermined level for a product of a high purchase rate by applying a weighting value to each product.

In addition, in the point service server according to an embodiment of the present invention, when a personalized coupon is created for each customer terminal, the analysis unit creates a personalized coupon of a discount rate or an accumulation rate increased for a product at a predetermined time point by applying a weighting value to a time point of each customer terminal using the store.

In addition, when the control unit receives the personal purchase information transmitted from the customer terminal, the point service server according to an embodiment of the present invention retransmits an advertisement message advertising other products highly probable to be purchased together with a product to be purchased by the customer terminal to the customer terminal based on accumulated information, and when the customer terminal is confirmed, the point service server coverts and confirms a card number of the in-store purchase card information using a customer ID conversion system.

At this point, in the point service server according to an embodiment of the present invention, when the customer terminal transmits the personal purchase information and the store terminal transmits the in-store purchase card information within a predetermined time, the point management unit increases the discount rate or the accumulation rate as much as a predetermined level.

In addition, in the point service server according to an embodiment of the present invention, when the store terminal transmits the in-store purchase card information, the control unit compares a purchase amount of a product purchased by the customer terminal with a predetermined accumulation rate or discount rate, additionally creates a personalized coupon including information on an additional purchase amount entitled to receive accumulation or discount benefit to maximum, and transmits the personalized coupon to the customer terminal.

At this point, in the point service server according to an embodiment of the present invention, the control unit transmits receipt information including information on a price of a product to which the accumulation rate or the discount rate is applied and information on current points of the customer terminal to the store terminal, and if product purchase of the customer terminal is completed, the control unit transmits purchase description and analysis information of a paid product to the manufacturer terminal.

Meanwhile, a personalized coupon providing method according to an embodiment of the present invention includes the steps of: analyzing a product data transmitted from a manufacturer terminal, creating a personalized coupon for each of a plurality of customer terminals, and transmitting the personalized coupon to the customer terminals; receiving personal purchase information corresponding to the personalized coupon, by the customer terminal; confirming, if the store terminal transmits in-store purchase card information, the customer terminal by matching the in-store purchase card information and the personal purchase information; and applying a point accumulation rate or a price discount rate to a purchase product according to the personal purchase information of the customer terminal.

According to the present invention, it is possible to provide a point system for transmitting a personalized coupon targeting a customer of high purchase involvement, performing a custom-tailored discount in an online or offline space if the customer reserves or directly purchases a product using the coupon, and capable of using all the services including confirmation of a coupon, accumulation of points, management of the points and the like through a point card, and a manufacturing company may conduct an efficient marketing campaign since a degree of sales using the coupons can be grasped.

In addition, a manufacturing company may conduct a target marketing campaign targeting a specific customer, and a customer group of high loyalty is formed since the customer receives an additional customer benefit by registering a purchase in advance, and thus a retail store accepting the personal custom-tailored coupon may increase sales.

### BRIEF DESCRIPTION OF THE DRAWINGS

FIG. 1 is an exemplary view showing a personalized coupon providing system according to an embodiment of the present invention.

FIG. 2 is an exemplary view showing the configuration of a point service server of a personalized coupon providing system according to an embodiment of the present invention.

FIG. 3 is an exemplary view showing the configuration of a customer terminal of a personalized coupon providing system according to an embodiment of the present invention.

FIGS. 4 and 5 are exemplary views showing a method of creating and providing a coupon by a personalized coupon providing system according to an embodiment of the present invention.

FIG. 6 is an exemplary view showing a method of using a personalized coupon by a customer terminal of a personalized coupon providing system according to an embodiment of the present invention.

FIG. 7 is an exemplary view showing a method of applying a discount rate and an accumulation rate of a personalized coupon by a point service server of a personalized coupon providing system according to an embodiment of the present invention.

### DESCRIPTION OF SYMBOLS

100: Manufacturer terminal
200: Point service server
201: Analysis unit
202: Communication unit
203: Control unit
204: Point management unit
205: Storage unit
300: Customer terminal
301: Communication unit
302: Control unit
303: Storage unit
304: Coupon verification unit
400: Store terminal

### DETAILED DESCRIPTION OF THE PREFERRED EMBODIMENT

First, the term ‘point’ used in the present invention is a bonus point provided to a customer in a variety of ways according to a purchase amount or the like at a corresponding site or store when the customer purchases a product or a service in an online or offline space as described above, and although it is called as various terms of ‘mileage’, ‘cashback’ and the like, they are all referred to as a point hereinafter.

Hereinafter, the present invention will be described in detail with reference to the drawings.

First, it is preferable for a customer terminal registered in a point service server to progress a procedure of being registered as a member of a point card to use the personalized coupon providing system of the present invention. A customer using the personalized coupon providing system creates a member registration application in advance offline or online and transmits information on the registration application to the point service server offline or online, and the point service server registers the customer as a member, transmits a member registration confirmation message to the corresponding customer terminal, and provides a point card to the customer offline or online.

Subsequently, the point service server may create issuance information and an application program according to the applied customer and download them to the provided customer terminal, and the personalized coupon providing registration procedure is completed if the point service server 200 inputs and registers a serial number, an issuance date and the like of the point card in the customer terminal 300 including the issuance information and application program.

The customer may purchase various products through the customer terminal 200 equipped with a medium having a security solution which is needed when a point service is provided and may be provided with services of the personalized coupon providing system by utilizing the point card.

That is, the customer may be registered in the point service server as a member and accumulate points, visit an offline store and purchase a product using only member information of the customer registered in the point service server as a member without a separate customer program, confirm a coupon provided offline and online, and receive point services in one medium.

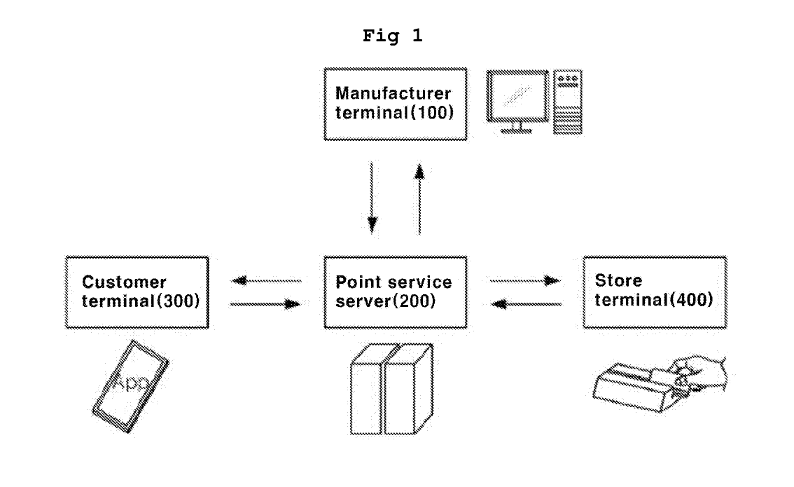

FIG. 1 is an exemplary view showing a personalized coupon providing system according to an embodiment of the present invention.

Referring to FIG. 1, a personalized coupon providing system of the present invention provides a personalized coupon to a customer by interconnecting a manufacturer terminal 100, a point service server 200, a customer terminal 300 and a store terminal 400.

More specifically, an embodiment of the personalized coupon providing system of the present invention includes the point service server 200 for informing information needed for the manufacturer terminal 100, the customer terminal 300 and the store terminal 400, by way of receiving a product data from the manufacturer terminal 100, converting the received product data into a personalized coupon, transmitting the personalized coupon to the customer terminal 300, receiving personal purchase information, matching the personal purchase information and in-store purchase card information received from the store terminal 400, and applying a discount rate and an accumulation rate.

At this point, the personalized coupon may be configured of characters, numerals, a bar code and a QR code, and the personalized coupon can be included in an electronic mail, an App, a web application program and transmitted to the customer terminal through the Internet or transmitted through a mobile communication network such as an SMS, MMS or the like.

In addition, the personalized coupon may be or transmitted by mail to a member who has joined a point service using a point card, and, in this case, a discount code may be configured in a form including at least any one of characters, numerals, a bar code, a QR code, a magnetic stripe and an IC chip.

In addition, the personalized coupon providing system preferably allows a medium (a magnetic or IC chip card including a bar code or a QR code) provided with a customer authentication module (a service (card) application capable of confirming a customer) to be accessed by an offline store such as a mart or an affiliate store, an online issuance service system using an order, or a mobile application.

Meanwhile, the manufacturer terminal 100 transmits a product data, and the customer terminal 300 receives a personalized coupon and transmits personal purchase information including information on a product to be purchased to the point service server. In addition, if information on a point card is input, the store terminal 400 transmits in-store purchase card information of the point card to the point service server, receives information on a receipt to which an accumulation rate or a discount rate is applied from the point service server, and outputs the receipt information.

The manufacturer terminal 100 is a terminal installed in an enterprise (e.g., Lotte Confectionary Co., Haitai Confectionary & Foods Co., Namyang Dairy Product Co.) which manufactures a product, and a personal computer (PC) or a portable terminal such as a smart phone, a touchpad or the like can be used as the manufacturer terminal 100.

The point service server 200 is an apparatus for analyzing the product data transmitted from the manufacturer terminal 100, creating a personalized coupon, receiving personal purchase information from the customer terminal 300, and applying and managing a discount rate and an accumulation rate, and can be implemented in the form of a recording medium including instructions executable by a computer, such as an application or a program module executed by a computer.

The customer terminal 300 is an apparatus personally possessed by a customer, which is an apparatus (e.g., a smart phone, a personal computer (PC), a tablet computer or the like) for reserving a product by transmitting personal purchase information corresponding to the personalized coupon received from the point service server 200, and receiving and updating accumulated point information when an actual purchase is completed.

The customer terminal 300 can be implemented in the form of a recording medium including instructions executable by a computer, such as an application or a program module executed by a terminal described above, in a general terminal device. A terminal readable medium may be a certain available medium that can be accessed by a terminal and may include all volatile and non-volatile media and removable and non-removable media and all terminal storage media and communication media. At this point, the computer storage media includes all volatile and non-volatile media and removable and non-removable media implemented in a certain method or technique for storing information such as terminal readable instructions, data structures, program modules or other data. The communication medium typically includes computer readable instructions, data structures, program modules, other data of a modulated data signal such as a carrier wave, or other transmission mechanisms, and if the communication medium includes a certain information transfer medium, it is included in the point service server of the present invention.

The store terminal 400 is an apparatus (e.g., a card reader or the like) through which a customer may present a point card and purchase a product at a discounted price and can be implemented in the form of a recording medium including instructions executable by a computer, such as an application or a program module executed in a store by a terminal described above, in a general terminal device.

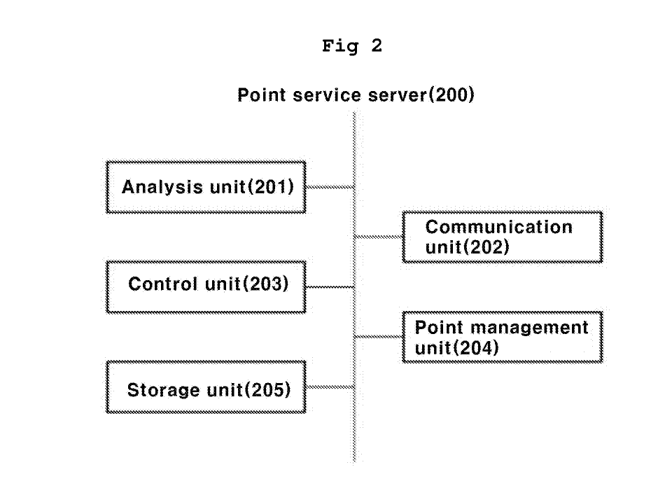

FIG. 2 is an exemplary view showing the configuration of a point service server of a personalized coupon providing system according to an embodiment of the present invention.

Referring to FIG. 2, a point service server of the personalized coupon providing system of the present invention may include an analysis unit 201, a communication unit 202, a control unit 203, a point management unit 204 and a storage unit 205.

The analysis unit 201 analyzes the product data transmitted from the manufacturer terminal and creates a personalized coupon for each of a plurality of customer terminals. At this point, the product data which can be input through the manufacturer terminal has a data format containing product information such as a quantity of a product, a product name, a data code, provided points, a manufacturer, an event period and the like, and the manufacturer terminal may receive personal purchase information of a customer, including details of product purchase and analysis information, after purchase from the point service server, grasp a tendency of the customer and create a new product data therefrom.

Particularly, the data code among the product data is for outputting a certain image data or contents, and if the data code is converted into an image data or contents of a two-dimensional bar code form (it can be an image data or contents of a one-dimensional bar code form, an image data or contents of a three-dimensional bar code form or an image data or contents of a color code form expressed by encoding a certain data according to the intention of those skilled in the art, or it can be a logo image or the like of a specific company), the product data confirms the data code as a data structure corresponding to certain two-dimensional bar code format information.

The data structure corresponding to the two-dimensional bar code format information can be a QR code, a Data Matrix Code, a Maxicode Code, a Codeone Code, a Code49 Code or a PDF-417 Code, i.e., a matrix type two-dimensional code.

In addition, when the product data is converted into a personalized coupon, it can be a raw data eliminating only a few elements from the original state of the product data, or corresponding mart information, customer information or the like can be added according to the form of a coupon to be transmitted to the customer.

The personalized coupon can be thereafter created as a new personalized coupon changing the scale, points, event period or the like on the basis of reception of analysis data, and a method of analyzing product information of accumulated purchased products and discounting a frequently purchased product furthermore, a method of advertising a product additionally purchased by those who have purchased a similar product, a method of performing a time sale based on time-base purchase information, a method of purchasing a product at a discounted price using possessed points or the like can be applied as an analysis method.

Subsequently, the analysis unit 201 of the point service server analyzes the product data transmitted from the manufacturer terminal and creates a personalized coupon for each of the plurality of customer terminals. The personalized coupon is a coupon created for each of the plurality of customer terminals, which includes a data aggregating information such as a quantity needed for a customer, a product name, points, an event period and the like among the information on the product data and has a data format simplified by the data conversion unit so that the information can be used in the coupon. At this point, the analysis unit 201 of the point service server analyzes the product data received from the manufacturer terminal and stored in the point service server and creates a personalized coupon that can be expressed on the customer terminal, and the coupon can be created by converting a large amount of data such as a target customer, a quantity, a product name, a data code, points, a manufacturer, an event period and the like existing in the product data, together with simple information such as a product name, a data code, a manufacturer, an event period and the like needed for the coupon, into a data of a text or image form which can be recognized by the customer as a coupon.

For example, if the manufacturer terminal transmits a product data of product A to the analysis unit, the analysis unit transmits a personalized coupon like ‘Product A of Z company, January 1^{st} to January 10^{th}, Discount rate 10%, Accumulation rate 10%’ to the customer terminals of the customers having a record of purchasing product A more than an accumulated amount of 100,000 Korean Won or within a week in accordance to the conditions such as a target customer (customers having a record of purchasing product A more than an accumulated amount of 100,000 Korean Won or within a week), a quantity (30 persons), points (an accumulation rate of 10%) and the like included in the product data.

In addition, the analysis unit 201 may analyze the accumulated data of the customer terminal and perform a time sale of a purchase product based on time-base purchase information of the customer. The discount rate may increase if the customer purchases the product again within a predetermined time from the purchase time, and corresponding information can be transmitted to the customer terminal after adding time unit information to the product purchase state. At this point, in order to advertise a product additionally purchased by other customers who have purchased a product similar to that of the customer, the analysis unit 201 may create a personalized coupon including a guidance message emphasizing the product through an analysis method and an analysis pattern for analyzing the product purchase state in the form of a mind map, a Tech-Tree or something similar thereto and transmit the coupon to the customer terminal.

For example, if ten customers purchase a paper, a pen and an eraser and other twenty customers purchase a candy, a chocolate and a gum, the paper, the pen and the eraser can be classified as a weak stem of a Tech-Tree, and the candy, the chocolate and the gum can be classified as a strong stem. If bread and milk is input through the mind map, the bread and the milk are tied as a group, and it is determined that a customer may purchase the products together by the stem or group.

The communication unit 202 transmits and receives data to and from any one of the manufacturer terminal, the customer terminal and the store terminal and transmits a personalized coupon to the customer terminal. At this point, the communication unit 202 is a communication device needed for the point service server to transmit and receive data to and from another device or terminal and may include a configuration operable according to various communication specifications which are currently used or will be used in the future.

If the customer terminal receives personal purchase information corresponding to the personalized coupon and the store terminal transmits in-store purchase card information, the control unit 203 confirms the customer terminal by matching the in-store purchase card information and the personal purchase information.

The personal purchase information is a data containing customer information needed for purchase and can be created by processing the in-store purchase card information, personal information and a purchase tendency of the customer, which are created when a payment is made, in a specific data format, and the personal purchase information may include information on a customer's card, a product selected by the customer terminal, a personalized coupon, a store selected by the customer terminal and the like in a data format simplifying the customer information to maintain security.

In a method of maintaining security of a personalized coupon, since coupons are provided only to individual customers having purchasing power, personal purchase information should be transmitted to the point service server through a reservation only when the identity is confirmed. That is, when a customer does not recognize theft of his or her personal information, the meaning of the coupons provided to individuals is blurred, and disadvantages such as invasion of privacy or the like can be encountered according to the theft of personal information. In addition, a manufacturer may suffer from a disadvantage of providing a discount service even to a customer who is not a customer having purchasing power. Accordingly, in such a purchase reservation environment, a personalized coupon transmitted to each individual should be verified as a coupon belonging to the customer, and, at this point, the problem of security can be prevented by converting the personal purchase information into simplified customer information such as a customer ID, a membership number, a point card number or the like so that the in-store purchase card information and the personal purchase information can be compared with each other.

The point management unit 204 applies a point accumulation rate or a price discount rate to a purchase product according to the personal purchase information of the customer terminal.

The point management unit 204 may manage points of a customer and perform calculation of points applied to a personalized coupon, which is different for each customer, when the customer purchases a product. In this case, points according to the purchase of the product can be accumulated, or accumulated points may be used to purchase a product, and a discount is applied to the purchase of a product, and this will be useful for the analysis of the personal purchase information.

In addition, in the process of collecting personal purchase information, which is conducted to use purchase description and analysis information of a product purchased and paid by the customer using a coupon provided by the point service server, the point management unit 204 may automatically convert a purchased product state of a customer into a document of a form selected by a manager, such as Hangul Word Processor (hwp), Microsoft Words (doc and docx), PowerPoint (ppt or pptx), Excel (xls and xlsx), Acrobat (pdf), Hunminjungum (gul) or the like.

In addition, the control unit 203 and the point management unit 204 may be implemented by a processor or the like capable of processing data and may be separated from each other and implemented by different processors or functionally separated within a processor.

On the other hand, the point management unit 204 may create rules of product discount rate or point accumulation rate in a variety of ways and may input points of each product according to a product data by applying various reasonable rules of product discount rate or point accumulation rate as shown in the examples described below.

In addition, when a customer purchases a product using a personalized coupon, the point management unit 204 calculates points of the product applied based on the previously set accumulation or discount rules. First, the point management unit 204 creates and stores a point providing rule configured of point items, point values, calculation rules and the like assigned to each product.

Such a work may set default values in the analysis unit 201 and can be defined by input of the manufacturer terminal, and a time element item can be added as an additional discount provided according to time-base purchase information of the analysis unit 201 and may be classified as a cost element item for adjusting the discount rate of each product.

Subsequently, the time element item can be largely divided into a personal purchase information creation time and an in-store purchase card information transmission time, and the cost element item may include a sales amount, a quantity, a margin, purchase description of a customer and the like. At this point, a time element, an item among the time elements, a cost element or an item among the cost elements may be specified as the point item, and both the time and cost elements may be specified.

In addition, the point management unit 204 may spread the purchase description of the customer, assign a weighting value by applying the point calculation rule when the time element of a product purchased multiple times is included within a predetermined period, and assign a weighting value when the quantity of a purchase product exceeds a predetermined level. In addition, the point management unit 204 may set a value according to the points calculated by the calculation rule, calculate points according to the accumulation rate in the point accumulation step if the customer presents a point card after purchase, and update information on the accumulated points.

The storage unit 205 stores data including at least one or more of the personalized coupon, the product data, the personal purchase information and the in-store purchase card information. At this point, the storage unit 205 may store various data such as the product data received from the point service server, the personalized coupon based on the product data, the in-store purchase card information of the point card presented by the customer when the customer purchases a product, the personal purchase information received through the customer terminal, point accumulation information and the like.

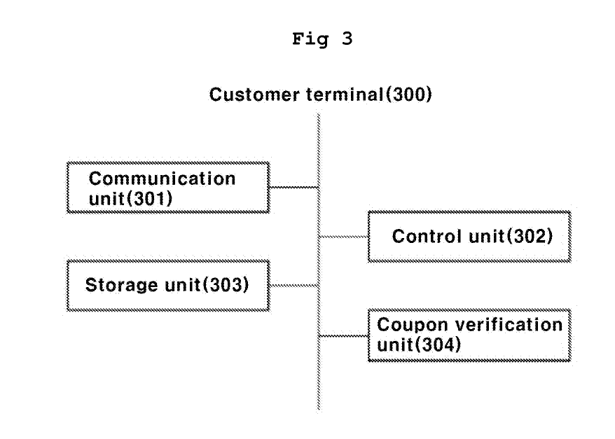

FIG. 3 is an exemplary view showing the configuration of a customer terminal of a personalized coupon providing system according to an embodiment of the present invention.

Referring to FIG. 3, the customer terminal 300 of the personalized coupon providing system of the present invention includes a communication unit 301 for communicating with the point service server 200, a control unit 302 for controlling operation of each configuration, a storage unit 303 for storing a personalized coupon received from the point service server 200, and a coupon verification unit 304 for verifying validity of the personalized coupon received from the point service server 200.

The communication unit is a communication device needed for the customer terminal 300 to transmit and receive data to and from the point service server 200 and includes a configuration operable according to various communication specifications which are currently used or will be used in the future.

The control unit 302 is a configuration for issuing a command to each configuration so that the configuration may operate according to its original function and may be implemented by a processor or the like capable of processing data, separately implemented by a different processor, or functionally separated within a processor. That is, the control unit 302 may include at least one arithmetic unit, and, here, the arithmetic unit may be a general-purpose central processing unit (CPU), a programmable device element (CPLD or FPGA) implemented to be suitable for a specific purpose, an application specific integrated circuit (ASIC) or a microcontroller chip.

The storage device 303 is a configuration for storing data, which can be implemented by a hard disk or the like, and may include all various media capable of storing data.

The coupon verification unit 304 may confirm that coupons are issued only to individual customers having purchasing power, implements a process for confirming that data received from different components are the same information, and may be separately implemented by a different processor or functionally separated within a processor.

Since a manufacturer may suffer from a disadvantage of providing a discount service even to a customer who is not a customer having purchasing power, a method of verifying the identity of a customer provided with a coupon transmitted to each individual is needed.

Accordingly, coupons are issued by the point service server only to individual customers having purchasing power, and the coupon verification unit 304 verifies the coupons by confirming the identity of a customer and transmits personal purchase information to the point service server through a reservation only when the identity is confirmed. At this point, the purchasing power is defined such that a customer has purchasing power when a frequency of purchasing a product or an amount of a product purchased by the customer exceeds a predetermined condition. A measure of the predetermined condition may vary in its feature depending on personal purchase information and a product type.

For example, a customer condition for determining a customer receiving a personalized coupon as a customer having purchasing power over product A when product A is discounted may be included in the personalized coupon. Such a customer condition may be an accumulated purchase amount of a corresponding product or may be determined based on the record of purchasing the product within a predetermined period. In addition, when such a customer condition is accumulated, a customer who has satisfied the customer condition more than several times may be specified.

If a personalized coupon converted from each product data is transmitted to the customer terminal of a corresponding customer, a target customer item included in the personalized coupon, a purchase state item obtained through a purchase state of the customer, and simplified personal information of the customer are compared with each other. At this point, the items compared by the coupon verification unit 304 may be a state of target customer scale and a purchase state of the customers, or simplified personal information of customers can be compared when the customers are specified or limited in the process of creating a personalized coupon.

When the personalized coupon including the customer condition matches the personal purchase information input by the customer through the customer terminal, the coupon verification unit 304 determines that the customer is included in the product discount list, creates personal purchase information, and transmits the personal purchase information to the point service server 200. At this point, the coupon verification unit 304 may transmit the personal purchase information in the form of a reservation or input the personal purchase information using a security solution (e.g., an IPIN, an authenticated certificate, a password or the like).

If the customer condition does not match the personal purchase information input through the customer terminal 300, the point service server determines that the customer terminal is not included in the product discount list and does not progress purchase of the product any more.

Like this, an additional discount can be provided only to the customers having purchasing power through a coupon by preventing theft of the coupon through the coupon verification unit 304 of the customer terminal, and customers of high loyalty can be secured since the personal purchase information obtained through the purchase can be analyzed, and, in addition, a product can be provided at a discounted low price.

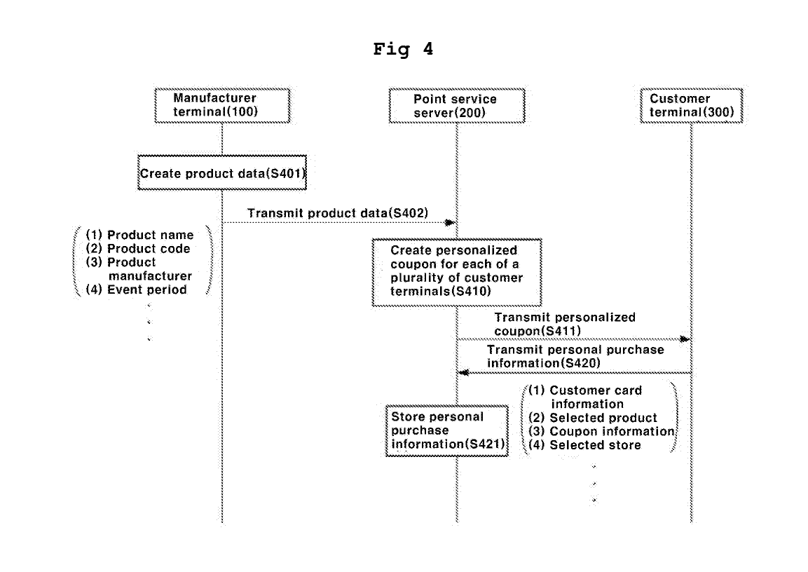

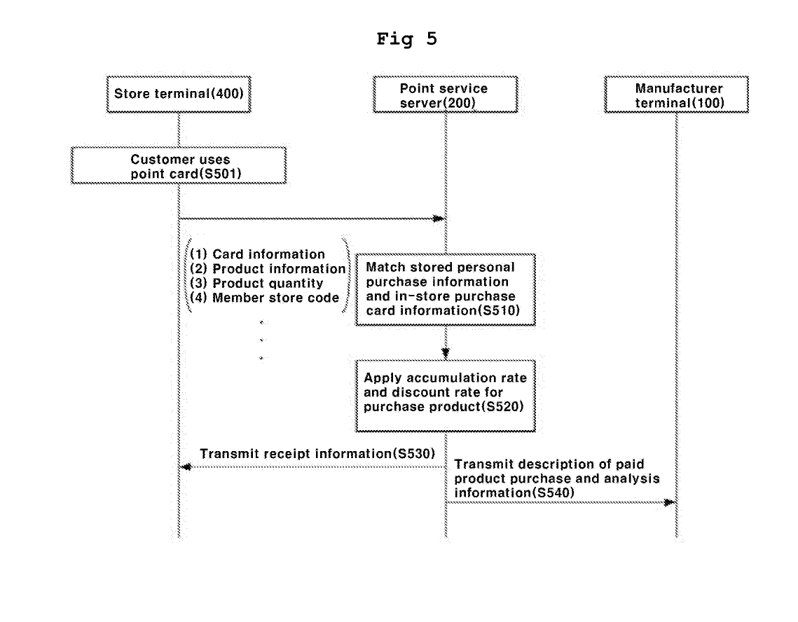

FIGS. 4 and 5 are exemplary views showing a method of creating and providing a coupon by a personalized coupon providing system according to an embodiment of the present invention.

Referring to FIG. 4, first, if an employee of a manufacturing company inputs product sales information such as target customers, a scale, a product name, a data code, points, a manufacturer, an event period and the like using a computer or a readable recording medium which stores a program for exercising the product sales information through the manufacturer terminal 100, the manufacturer terminal 100 creates a product data corresponding to the product sales information (step S401) and transmits the created product data to the point service server 200 (step S402).

At this point, the target customers, the scale, the product name data code, the points, the manufacturer, the event period and the like input by the employee of a manufacturing company may be a certain value determined by the manufacturer or a value obtained from analysis information provided by the point service server. For example, when beer is specified as an event product, an employee of a manufacturing company determines a discount rate of 10% and an accumulation rate of 10%, which do not exceed a discount rate of 15% and an accumulation rate of 15% set by the manufacturing company. However, if the analysis information transmitted from the point service server shows that the sales rate of the beer is lower than a reference value by 10%, it may be attempted to increase the sales rate by increasing the discount rate to 15% and the accumulation rate to 15% by adding a rate of 5% to sell the product more than the reference value.

In addition, if the analysis information transmitted from the point service server shows that a customer also purchases a fried food when the customer purchases beer, sales of the fried food can be increased by temporarily transmitting a personalized coupon of a 5% discount rate and a 5% accumulation rate for the fried food to the customer purchasing the beer.

Subsequently, the point service server stores the received product data and creates a personalized coupon for a plurality of customer terminals (step S410) and transmits the personalized coupon to the customer terminals (step S411).

If the customer terminal transmits personal purchase information including customer card information, a selected product, personalized coupon information, a selected store and the like (step S420), the point service server stores the corresponding personal purchase information (step S421).

At this point, if customer information of the personalized coupon transmitted to each customer matches the personal purchase information input through the customer terminal by the customer, the point service server determines that validity of the personalized coupon of the customer is proved and determines that purchase of the product is reserved through the steps of transmitting the personal purchase information (step S420) and storing the corresponding personal purchase information by the point service server (step S421). However, if the personal purchase information input through the customer terminal by the customer does not match the customer information of the personalized coupon, the point service server determines that validity of the personalized coupon is not proved and does not progress purchase of the product any more.

Referring to FIG. 5, after a predetermined time is elapsed, a customer visits a store, purchases a product and inputs purchase information into the store terminal through a point card (step S510).

The store terminal transmits in-store purchase card information including card information, product information, a quantity of the product, a member store code and the like to the point service server (step S502).

Subsequently, the point service server confirms the customer terminal by matching the transmitted in-store purchase card information and the personal purchase information (step S510) and applies a point accumulation rate or a price discount rate to a purchase product according to the personal purchase information of the customer terminal (step S520).

In the process of confirming the customer terminal by matching the in-store purchase card information and the personal purchase information (step S510), the process of purchasing the product can be continuously progressed only when the received personalized coupon is valid. However, if the in-store purchase card information does not match the personal purchase information, the point service server determines that the personalized coupon is not belonged to the customer and does not progress the purchase.

At this point, as a process of applying a point accumulation rate and a price discount rate to a purchase product (step S520), first, a point providing rule configured of point items, point values, calculation rules and the like assigned to each product is created and stored. Such a work may set default values within the analysis unit 201 and can be defined by input of the manufacturer terminal. A time element point item can be added to the point items according to an additional discount based on time-base purchase information of the analysis unit and may be classified as a cost element item for adjusting the discount rate of each product. The time element item can be largely divided into a personal purchase information creation time and an in-store purchase card information transmission time, and the cost element item may include a sales amount, a quantity, a margin, purchase description of a customer and the like. At this point, a time element, an item among the time elements, a cost element or an item among the cost elements may be specified as the point item, and, in addition, both the time and cost elements may be specified. Using the point calculation rule, the point management unit 204 may spread the purchase description of the customer, assign a weighting value when the time element of a product purchased multiple times is included within a predetermined period, and assign a weighting value when the quantity of a purchase product exceeds a predetermined level. In addition, the point management unit 204 sets a value according to the points calculated by the calculation rule, calculates points according to the accumulation rate in the point accumulation step if the customer presents a point card after purchase, and updates information on the accumulated points.

Finally, the point service server transmits information on the receipt of the product to which the accumulation rate and the discount rate are applied (step S530) so that the customer may confirm and transmits purchase description and analysis information of a paid product to the manufacturer terminal (step S540).

At this point, if the customer purchases the product and presents a point card for accumulating points to the store terminal after the transaction, the store terminal should authenticates the identity of the customer regardless of the payment information and request the point service server to accumulate points.

If the store terminal transmits point in-store purchase card information authenticating the identity of the customer to the point service server, the point service server matches the in-store purchase card information based on the request of point accumulation and the personal purchase information possessed by the point service server 200, and to this end, the control unit 203 may match the personal purchase information converted into simplified customer information, e.g., a customer ID, a membership number, a point card number or the like, and the in-store purchase card information.

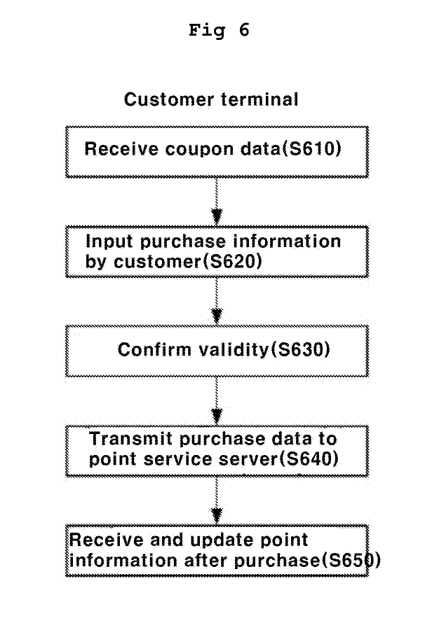

FIG. 6 is an exemplary view showing a method of using a personalized coupon by a customer terminal of a personalized coupon providing system according to an embodiment of the present invention.

Referring to FIG. 6, the customer terminal 300 of the present invention may include the steps of receiving a personalized coupon from the point service server 200 and storing the personalized coupon (step S610), inputting purchase information through the customer terminal 300 by a customer (step S620), confirming validity of the received personalized coupon (step S630), transmitting personal purchase information to the point service server 200 (step S640), and receiving updated point information from the point service server 200 after purchase (step S650).

First, the point service server may transmit a personalized coupon to a customer terminal through a variety of message transmission methods such as an SMS, an e-mail, a push message and the like. At this point, the personalized coupon can be encrypted by a security key which is shared among the point service server 200, the customer terminal 300 and the store terminal 400.

Subsequently, if the personalized coupon is received, the customer inputs purchase information into the customer terminal 300 based on the personalized coupon (step S620). The customer expresses an intention of purchase by inputting purchase information such as a product name, points, customer information, a selected mart and the like, which are items included in the personalized coupon, and the purchase product is reserved and can be used as a transaction tool when the product is purchased. Information on the reserved product and the customer is provided to the point service server 200 in the form of personal purchase information.

Meanwhile, the customer terminal may confirm validity of the personalized coupon. When the point service server provides the customer with the personalized coupon, it is important to provide the personalized coupon only to a customer having high purchasing power, and thus a process of confirming validity of the personalized coupon is performed to confirm whether or not other people use the coupon without permission.

To this end, in the step of verifying validity of the personalized coupon received from the point service server (step S403), transmission of the personal purchase information is progressed through a reservation only when the received personalized coupon is valid. At this point, the step of verifying validity may use a security solution including security information such as an IPIN, an authenticated certificate, a password or the like.

Subsequently, if validity is confirmed, a purchase reservation of the product is automatically progressed through the personal purchase information, and the personal purchase information input through the customer terminal is transmitted to the point service server (step S640).

The point service server determines that the purchase reservation of the product is completed as the personal purchase information is stored, and if in-store purchase card information is transmitted from the store terminal later, it may use the in-store purchase card information when a discount rate or an accumulation rate is applied by comparing the in-store purchase card information with the stored personal purchase information.

In addition, information on a received payment request is examined to determine whether or not the payment request is a request of a legitimate customer, and if the customer is confirmed to be legitimate, purchase of the product using points is progressed, and information on the subtraction of points is processed by the point management unit 204 so that information on the consumed points can be updated and conveniently confirmed in the customer terminal.

At this point, information on the subtraction of points is transferred to the store terminal and the point service server, as well as the customer terminal, to update the point information. Furthermore, information on a product, which is a target of accumulation and use of points among the products shown in the receipt, can be confirmed together.

For example, if a customer purchases product A (10,000 Korean Won) without using a personalized coupon, purchases existing product B (20,000 KW) at a sale price (15,000 KW) by applying a discount rate of 10% and an accumulation rate of 10% using a personalized coupon, and purchases product C (500 KW) using 500 points out of 10,000 points possessed by the customer without consuming cash, a record of ‘Purchase product A at 10,000 KW, Purchase product B at 13,500 KW by applying an additional discount of 10% and accumulate 100 points by applying 10% additional points, Purchase product C using 500 points, Remaining points 9,600’ is printed on the receipt and informed to the customer, and information on the purchase, information on using the personalized coupon and information on the accumulation of points can be informed by expressing them on the customer terminal in a method of screen display, sound or vibration.

Accordingly, the customer may confirm information on a product which is a target of accumulating and using points among the products purchased by the customer, and thus an effect of advertising the product which is a target of accumulating and using points can be obtained.

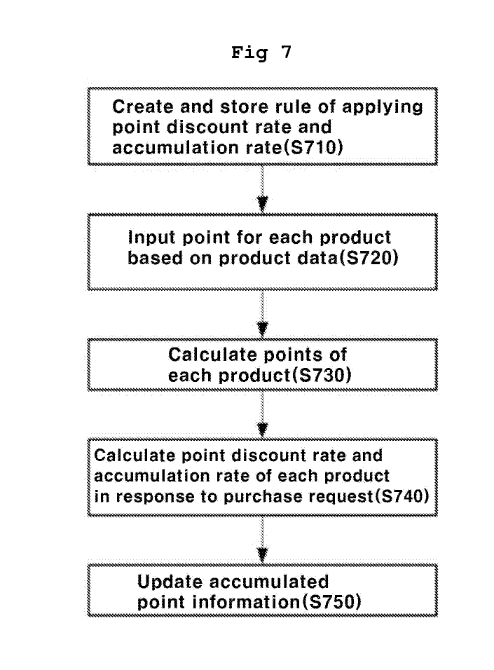

FIG. 7 is an exemplary view showing a method of applying a discount rate and an accumulation rate of a personalized coupon by a point service server of a personalized coupon providing system according to an embodiment of the present invention.

Referring to FIG. 7, a method of applying a discount rate and an accumulation rate of a point service server of the present invention includes the steps of creating and storing a rule of applying the discount rate and the accumulation rate (step S710), inputting points of each product according to a product data (step S720), calculating the points of each product (step S730), calculating a discount rate and an accumulation rate of each product in response to a purchase request (step S740), and updating information on accumulated points (step S750).

At this point, the point service server may issue a personalized coupon to maintain loyalty of customers having purchasing power and provide various discount benefits, create and store a rule of applying a discount rate or a point accumulation rate for each coupon, and collect personal purchase information and create a purchase product state of each customer as a list.

At this point, in the process of creating the list, the list can be automatically converted into a document of a form selected by a manager, such as Hangul Word Processor (hwp), Microsoft Words (doc or docx), PowerPoint (ppt or pptx), Excel (xls or xlsx), Acrobat (pdf), Hunminjungum (gul) or the like, or converted to be suitable for a form of the store terminal.

In addition, a method of performing an accumulation operation on the listed data, confirming information on purchase of a product within a predetermined period after purchasing the same product using a coupon provided by the point service server, and increasing the discount rate can be progressed.

In addition, a state of accumulated purchase amount, which allows a customer to confirm a discount rate which increases when the purchase amount satisfies a predetermined purchase amount, can be added to the personalized coupon in an algorithm increasing the product discount rate, and a manager may periodically grasp a purchase pattern, as well as a list of purchased products, through the purchased product state created as a list and perform a marketing campaign allowing the customer to purchase the same product at a lower price.

Subsequently, a method of persuading customers to periodically purchase a same product using a method of performing a time sale also can be added by adding time-base purchase information in the process of creating the data list.

Meanwhile, the point service server may analyze the product data including at least one or more of a product quantity, a product name, a product data code, provided product points, a product manufacturer and an event period and create personalized coupons of different discount rates or different accumulation rates for different customer terminals.

For example, when the point service server sets a criterion of a customer having purchasing power as ten times of purchase within thirty days for product C transmitted by the manufacturer terminal, if customer A purchases product C ten or more times in thirty days, the point service server determines customer A as a customer having purchasing power for product C and may issue a personalized coupon of a 20% discount rate and a 20% accumulation rate to customer A and issue a personalized coupon of a 5% discount rate and a 5% accumulation rate to customer B in transmitting a personalized coupon to customer A having high purchasing power and customer B having low purchasing power.

In addition, considering that the purchasing power varies for each product, the personalized coupon can be separately created, and different personalized coupons can be provided to customer A and B for different products.

For example, when the criterion of a customer having purchasing power over product D is 10,000 KW or more within ten days, if customer B purchases 10,000 KW or more worth of product D in ten days and customer A does not purchase product D, a personalized coupon for product D is not issued to customer A, and a personalized coupon of a 10% discount rate and a 10% accumulation rate can be issued to customer B.

When a personalized coupon is created for each customer terminal, the point service server may analyze accumulated purchased products of the customer terminal, create a personalized coupon increasing the discount rate or the accumulation rate as much as a predetermined level for a product having a high purchase rate by applying a weighting value to each product, and create a personalized coupon increasing the discount rate or the accumulation rate for a product at a predetermined time point by applying a weighting value to a time point of each customer terminal using the store.

For example, when the point service server creates a personalized coupon of a 10% discount rate and a 10% accumulation rate for cookies and meat for customer A, if customer A shows a pattern of purchasing the cookies and meat frequently when the customer purchases products at normal times, it may create a personalized coupon of a 20% discount rate and a 20% accumulation rate by increasing the rates as much as 10% determined in advance.

In addition, when customer B shows a tendency of using a point card between 19:00 and 21:00 o'clock at normal times, the point service server may transmit a guidance message informing that “if this coupon is used between 19:00 and 21:00 o'clock, 10% more discount rate and accumulation rate will be applied” to customer B and issue a coupon applying the rates considering the tendency of customer B when the point service server provides a personalized coupon to customer B.

Meanwhile, when the customer terminal receives the personal purchase information, the point service server may retransmit an advertisement message advertising other products highly probable to be purchased together with a product to be purchased by the customer terminal to the customer terminal based on accumulated personal purchase information.

For example, when customer A transmits personal purchase information to the point service server to purchase a beverage and fish, the point service server may derive bread, condiments and the like, which are other products purchased by other customers together with the beverage and fish, by analyzing accumulated data, provide customer A with a personalized coupon applying a discount rate of 10% and an accumulation rate of 10% to the bread and condiments, and retransmit an advertisement message including contents advertising the bread and condiments to the customer terminal.

When the point service server creates a personalized coupon for each customer terminal, it may set the number of times of purchase or a purchase amount regardless of a product and additionally create a personalized coupon increasing the discount or accumulation rate of the total product purchase amount when the number of times of purchase or the purchase amount of the customer exceeds a predetermined level in order to promote the use of the personalized coupon.

For example, when the number of times of using a personalized coupon within thirty days is over twenty times and the point service server creates a personalized coupon applying a discount rate of 5% and an accumulation rate of 5% to the total amount of a product purchased 21^{st}, if the number of times of purchasing the product by customer A using the personalized coupon is twenty times in total, the point service server may transmit a guidance message informing that “At the 21^{st} visit, 5% of the total amount will be further discounted and accumulated for any product” through the customer terminal and issue a coupon applying the rates.

In addition, the point service server transmits the guidance message every five times of purchase to promote the use of the personalized coupon, and through the customer terminal, the customer may confirm the remaining number times of using the personalized coupon until an additional personalized coupon is issued.

In addition, when the customer terminal transmits the personal purchase information and the store terminal transmits the in-store purchase card information within a predetermined time, the point service server may increase the discount rate or the accumulation rate as much as a predetermined level, compare a purchase amount of a product purchased by the customer terminal with a predetermined accumulation rate or discount rate, additionally create a personalized coupon including information on an additional purchase amount entitled to receive accumulation or discount benefit to the maximum, and transmit the personalized coupon to the customer terminal.

For example, when customer B transmits a product to be purchased and details of a personalized coupon to the point service server at 17:00 o'clock using the customer terminal and uses a point card at 17:30 o'clock using the store terminal, the point service server may confirm that the point card is used within a previously set time (e.g., one hour) and further issue a personalized coupon increasing the discount rate and the accumulation rate by 10% respectively.

In addition, when customer A purchases 1.5 L of milk and 1.5 Kg of meat and uses a point card, the point service server may additionally create a personalized coupon informing that the discount rate and the accumulation rate will be increased by 10% if the customer purchases the milk and meat 500 mL and 0.5 Kg more, issue and transmit a personalized coupon including information on an additional purchase amount entitled to receive accumulation or discount benefit to the maximum, and transmit the personalized coupon to the customer terminal.

Meanwhile, the personalized coupon providing method of the present invention may be implemented by a computer readable medium or a terminal readable medium. The computer readable medium may be a certain available medium that can be accessed by a computer and includes all volatile and non-volatile media and removable and non-removable media.

In addition, the computer readable medium may include all computer storage media and communication media. The computer storage medium includes all volatile and non-volatile media and removable and non-removable media implemented in a certain method or technique for storing information such as computer readable instructions, data structures, program modules or other data.

The communication medium typically includes computer readable instructions, data structures, program modules, other data of a modulated data signal such as a carrier wave, or other transmission mechanisms, and if the communication medium includes a certain information transfer medium, it is included in the point service server of the present invention.

The terminal readable medium may be a certain available medium that can be accessed by a terminal and includes all volatile and non-volatile media and removable and non-removable media. In addition, the terminal readable medium may include all terminal storage media and communication media.

The computer storage medium includes all volatile and non-volatile media and removable and non-removable media implemented in a certain method or technique for storing information such as computer readable instructions, data structures, program modules or other data.

The communication medium typically includes computer readable instructions, data structures, program modules, other data of a modulated data signal such as a carrier wave, or other transmission mechanisms, and if the communication medium includes a certain information transfer medium, it is included in the point service server of the present invention.

In addition, a method of providing a customer with additional discount information through a signal such as a screen display, an alarm, a vibration or a sound within a time of purchasing again can be added in an algorithm capable of increasing a discount rate of a product if the customer purchases the same product again, and customers having purchasing power can be confirmed by grasping accumulated purchase amounts of the customers at a glance, and a lot of customers of high loyalty to the same product can be secured by adopting a method of discounting more than an existing discount rate for frequently purchased products.

In addition, a method of analyzing a product purchase state in the form of a mind map, a Tech-Tree or something similar thereto can be added using an algorithm used in an advertisement method, and a method of emphasizing a product discounted through a coupon among various products purchased by other customers can be used through an analysis pattern.

The products purchased by other customers are connected using the analysis pattern, and purchase product data of several customers are accumulated, and most frequently overlapped products are transmitted in the step transmitting point information, together with a product discounted using a coupon. A customer may confirm discount information of other products that can be additionally purchased in addition to the previously purchased products through the advertisement method, and a method of advertising discount prices of other purchase products of the customer who has purchased a similar product can be used to persuade a customer to purchase other products at a low price using purchase psychology of the customer.

For example, if ten customers purchase vegetable, condiments and an alcoholic beverage through personalized coupons and another ten customers purchase meat, noodles and an alcoholic beverage through personalized coupons, the products are associated like vegetable-condiments-alcoholic beverage and meat-noodles-alcoholic beverage, and if customer A mainly purchases only fish and uses a personalized coupon of a 10% discount rate and a 10% accumulation rate, a personalized coupon of a 5% discount rate and a 5% accumulation rate for condiments and fish is issued through the customer terminal of customer A, and a personalized coupon capable of providing discount and accumulation for meat, noodle and alcoholic beverage is advertised.

From the standpoint of a product seller, the present invention has an effect of enhancing the total sales profit by increasing probability of purchase through discount information on the products purchased by customers similar to the customer and persuading a customer of a high purchase frequency to purchase various products.

In addition, potential purchase customers who do not use a store for a predetermined time period can be selected, and the personalized coupon service can be advertised and customers purchasing products of other companies can be attracted by temporarily issuing a personalized coupon including a discount benefit of small amount to the potential purchase customers.

For example, if customer A does not use store B for 180 days, an advertisement informing customer A of “A personalized coupon of a 10% discount rate and a 10% accumulation rate is provided if you purchase meat five times or more in thirty days” is transmitted to the customer terminal by transmitting a one-time personalized coupon of a 5% discount rate and a 5% accumulation rate for meat to the customer who does not use the store for 180 days or more. In addition, an advertisement message including “If a personalized coupon of a 10% discount rate and a 10% accumulation rate for meat is provided, you may receive a discount coupon of a 5% discount rate and a 5% accumulation rate for noodles and alcoholic beverages” also can be transmitted by applying the advertisement using accumulated data.

It will be appreciated by those of ordinary skill in the art that the present invention may be embodied in other specific forms without departing from the spirit and essential characteristics of the present invention. Therefore, the embodiments described above are to be understood as merely illustrative and not restrictive limiting the scope of the present invention. In addition, the flowcharts shown in the figures are merely sequential orders shown for illustrative purposes to achieve the most desirable result in embodying the present invention, and it is apparent that other additional steps may be provided, or some steps may be deleted.

Embodiments of the subject matter and the functional operations described in this specification can be implemented in digital electronic circuitry, or in computer software, firmware, or hardware including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by or to control the operation of a data processing apparatus.

The tangible program carrier can be a computer readable medium, which can be a machine readable storage device, a machine readable storage substrate, a memory device, a composition of matter effecting a machine readable propagated signal, or any combination thereof.

Meanwhile, the term “apparatus” or “system” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or any combination thereof.

A computer program (also referred to as a program, software, software application, script, or code) can be written in any form of programming language, including compiled or interpreted languages, or declarative or procedural languages, and can be deployed in any form, including as a stand-alone program or as a module, component, subroutine, or other unit suitable for use in a computing environment. The computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). The computer program can be deployed to be executed on one computer or on multiple computers that are located at one site or distributed across multiple sites and interconnected by a wired/wireless communication network.

Computer readable media suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. Further, the processor and memory can be supplemented by, or incorporated in, special purpose logic circuitry.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

Hereinafter, further specific embodiments capable of implementing the configurations included in the system and the personalized coupon providing method described in this specification together with the contents described above will be described in detail.

The system and the personalized coupon providing method described in this specification may be partially or entirely used through a means which executes computer software, program codes or instructions on a server related to a client device or a web-based storage system or one or more processors included in the server. Here, the processor may be part of a computing platform such as a server, a client, a network infrastructure, a mobile computing platform, a fixed computing platform or the like, and, specifically, the processor may be any type of computer or processing device capable of executing program instructions, codes and the like. In addition, the processor may further include memory for storing the personalized coupon providing method, instructions, codes and programs, and if the processor does not include the memory, the processor can access, through a separate interface, a storage device such as CD-ROM, DVD, memory, hard disk, flash drive, RAM, ROM, cache or the like storing the personalized coupon providing method, instructions, codes and programs.

In addition, the system and the personalized coupon providing method described in this specification may be partially or entirely used through an apparatus executing computer software on a server, a client, a gateway, a hub, a router or network hardware. Here, the software may be executed on various kinds of servers such as a file server, a print server, a domain server, an Internet server, an Intranet server, a host server, a distributed server and the like, and the servers may include a memory, a processor, a computer readable storage medium, a storage medium, a communication device, a port, a client and an interface capable of accessing the other servers through a wired or wireless network. In addition, the personalized coupon providing method, instructions and codes for providing a personalized coupon also can be executed by a server, and other devices needed to execute the personalized coupon providing method may be implemented as part of a hierarchical structure associated with a server.

In addition, the server may provide an interface to other devices including, but not limited to, clients, other servers, printers, database servers, print servers, file servers, communication servers, distributed servers and the like, and a connection through the interface may facilitate remote execution of a program through a wired or wireless network. In addition, any one of the devices connected to the server through an interface may include at least one storage device capable of storing the personalized coupon providing method, instructions, codes and the like, and a central processor of the server may provide instructions, codes or the like to be executed on different devices to the devices so as to be stored in the storage device.

On the other hand, the system and the personalized coupon providing method described in this specification may be partially or entirely used through a network infrastructure. Here, the network infrastructure may include devices such as a computing device, a server, a router, a hub, a firewall, a client, a personal computer, a communication device, a routing device and the like and separate modules capable of executing a function of its own, and in addition to the devices and modules mentioned above, the network infrastructure may further include a storage medium such as a flash memory, a buffer, a stack, RAM, ROM or the like. In addition, the personalized coupon providing method, instructions and codes may also be executed and stored by any one of the devices, modules and storage media included in the network infrastructure, and other devices needed to execute the personalized coupon providing method may also be implemented as part of the network infrastructure.

The system and the personalized coupon providing method described in this specification may be implemented in hardware or a combination of hardware and software appropriate to a specific application. Here, the hardware may include general purpose computer devices such as a personal computer, a mobile communication terminal and the like and enterprise specific devices, and the computer device may be implemented as a device including a memory, a microprocessor, a microcontroller, a digital signal processor, an application specific integrated circuits, a programmable gate array, a programmable array logic or the like or a combination of these.

The computer software, instructions, codes and the like described above may be stored or accessed by a readable device, and, here, the readable device may include memory such as a computer component provided with digital data used for computing for a predetermined time period, a semiconductor storage such as RAM or ROM, a permanent storage such as an optical disk, a mass storage such as a hard disk, a tape, a drum or the like, an optical storage such as a CD or a DVD, a flash memory, a floppy disk, a magnetic tape, a paper tape, a stand-alone RAM disk, a mass storage which can be mounted on a computer, a dynamic memory, a static memory, a variable storage, a network connection type storage such as a cloud and the like. Meanwhile, here, although the instructions, codes and the like includes all of languages such as a data-oriented language such as SQL, dBase or the like, a system language such as C, Objective C, C++, assembly or the like, an architecture language such as Java, NET or the like and an application language such as PHP, Ruby, Perl, Python or the like, it is not limited thereto and may include all the languages widely known to those skilled in the art.

In addition, the term “computer readable medium” described in this specification refers to any medium that participates in providing instructions to a processor to execute a program. Specifically, although the medium includes a non-volatile medium such as a data storage device, an optical disk, a magnetic disk or the like, a volatile medium such as a dynamic memory or the like, and a transmission medium for transmitting data, such as a coaxial cable, a copper wire, an optical fiber or the like, it is not limited thereto.

Meanwhile, all the elements executing technical features of the present invention included in the block diagrams and flowcharts shown in the accompanying drawings of the present invention mean logical boundaries between the elements. However, according to an embodiment of software or hardware, elements and features shown in the figures are implemented in the form of an independent software module, a monolithic software structure, a code, a service or a combination of these, and since the functions of the elements and features can be implemented by storing them in a medium which can be executed in a computer provided with a processor capable of executing stored program codes, instructions and the like, all the embodiments can also be regarded as within the scope of the present invention.

Accordingly, although the accompanying drawings and descriptions thereof explain technical features of the present invention, the technical features should not be simply deduced while a specific array of software for implementing the technical features is not mentioned clearly. That is, various embodiments described above may exist, and since part of such embodiments can be modified while possessing technical features the same as those of the present invention, this can also be regarded as within the scope of the present invention.

In addition, while operations are depicted in a particular order in the flowcharts of the drawings, this should not be understood as requiring that such operations be performed in the particular order shown or in sequential order, or that all illustrated operations be performed, to achieve desirable results. In certain circumstances, multi-tasking and parallel processing can be advantageous. Moreover, the separation of various system components in the embodiments described above should not be understood as requiring such separation in all embodiments and it should be understood that the described program components and systems can generally be integrated together in a single software product or packaged into multiple software products.

As described above, this specification is not intended to limit the present invention to the presented specific terms. While the present invention has been described in detail with reference to the particular illustrative embodiments, those skilled in the art can alter, change or modify the embodiments without departing from the scope and spirit of the present invention. The scope of the present invention is defined by the accompanying claims, rather than the above detailed description, and the meaning and scope of the claims and all changes and modifications derived from equivalents thereof should be interpreted as being included in the scope of the present invention.

What is claimed is:

1. A personalized coupon providing system comprising:
a point service server for creating and transmitting a personalized coupon to each of a plurality of customer terminals and, if the customer terminal receives personal purchase information corresponding to the personalized coupon and a store terminal receives in-store purchase card information, confirming the customer terminal by matching the in-store purchase card information and the personal purchase information, and applying a point accumulation rate or a price discount rate to a purchase product according to the personal purchase information.

2. The system according to claim 1, further comprising:
a manufacturer terminal for transmitting a product data;
the customer terminal for receiving the personalized coupon and transmitting the personal purchase information including information on a product to be purchased to the point service server; and
the store terminal for transmitting, if information on a point card is input, the in-store purchase card information of the point card to the point service server, receiving information on a receipt to which the accumulation rate or the discount rate is applied, and outputting the receipt information.

3. A point service server comprising:
an analysis unit for analyzing a product data transmitted from a manufacturer terminal and creating a personalized coupon for each of a plurality of customer terminals;
a communication unit for transmitting and receiving data to and from any one of the manufacturer terminal, the customer terminal and a store terminal and transmitting the personalized coupon to the customer terminal;
a control unit for confirming, if the customer terminal receives personal purchase information corresponding to the personalized coupon and the store terminal transmits in-store purchase card information, the customer terminal by matching the in-store purchase card information and the personal purchase information;
a point management unit for applying a point accumulation rate or a price discount rate to a purchase product according to the personal purchase information of the customer terminal; and
a storage unit for storing data including at least one or more of the personalized coupon, the product data, the personal purchase information and the in-store purchase card information.

4. The server according to claim 3, wherein the analysis unit analyzes the product data including at least one or more of a product quantity, a product name, a product data code, provided product points, a product manufacturer and an event period and creates personalized coupons of different discount rates or different accumulation rates for different customer terminals.

5. The server according to claim 3, wherein when a personalized coupon is created for each customer terminal, the analysis unit analyzes accumulated purchased products of the customer terminal and creates a personalized coupon increasing the discount rate or the accumulation rate as much as a predetermined level for a product having a high purchase rate by applying a weighting value to each product.

6. The server according to claim 3, wherein when a personalized coupon is created for each customer terminal, the analysis unit creates a personalized coupon of a discount rate or an accumulation rate increased for a product at a predetermined time point by applying a weighting value to a time point of each customer terminal using the store.

7. The server according to claim 3, wherein when the customer terminal receives the personal purchase information, the control unit retransmits an advertisement message advertising other products highly probable to be purchased together with a product to be purchased by the customer terminal to the customer terminal based on accumulated personal purchase information.

8. The server according to claim 3, wherein when the customer terminal is confirmed, the control unit coverts and confirms a card number of the in-store purchase card information using a customer ID conversion system.

9. The server according to claim 3, wherein when the customer terminal transmits the personal purchase information and the store terminal transmits the in-store purchase card information within a predetermined time, the point management unit increases the discount rate or the accumulation rate as much as a predetermined level.

10. The server according to claim 3, wherein when the store terminal transmits the in-store purchase card information, the control unit compares a purchase amount of a product purchased by the customer terminal with a predetermined accumulation rate or discount rate, additionally creates a personalized coupon including information on an additional purchase amount entitled to receive accumulation or discount benefit to maximum, and transmits the personalized coupon to the customer terminal.

11. The server according to claim 3, wherein the control unit transmits receipt information including information on a price of a product to which the accumulation rate or the discount rate is applied and information on current points of the customer terminal to the store terminal.

12. The server according to claim 3, wherein if product purchase of the customer terminal is completed, the control unit transmits purchase description and analysis information of a paid product to the manufacturer terminal.

13. A personalized coupon providing method of a point service server, the method comprising the steps of:
analyzing a product data transmitted from a manufacturer terminal, creating a personalized coupon for each of a plurality of customer terminals, and transmitting the personalized coupon to the customer terminals;
receiving personal purchase information corresponding to the personalized coupon, by the customer terminal;
confirming, if the store terminal transmits in-store purchase card information, the customer terminal by matching the in-store purchase card information and the personal purchase information; and
applying a point accumulation rate or a price discount rate to a purchase product according to the personal purchase information of the customer terminal.
